(19) United States
(12) Patent Application Publication
(10) Pub. No.: US 2013/0337163 A1
(43) Pub. Date: Dec. 19, 2013

(54) METHOD FOR PREPARING WOVEN FABRIC EXCELLENT IN DEODORIZING AND HEAT-GENERATING EFFECTS

(71) Applicant: Myung Whan KIM, Seoul (KR)

(72) Inventor: Myung Whan KIM, Seoul (KR)

(21) Appl. No.: 13/523,560

(22) Filed: Jun. 14, 2012

(51) Int. Cl. B05D 5/00; B05D 3/02; B05D 7/24

(52) U.S. Cl. 427/202; 427/372.2; 427/389.9

(57) ABSTRACT

A method for preparing a woven fabric excellent in deodorizing and heat-generating effects and, more particularly to, a method for preparing a woven fabric excellent in deodorizing and heat-generating effects that includes: a heat-generating composition preparation step for blending a component providing a feeling of warmness to prepare a heat-generating composition; a heat-generating composition applying step for applying the heat-generating composition of the heat-generating composition preparation step onto a woven fabric; a deodorizing component applying step for applying a deodorizing component onto the woven fabric coated with the heat-generating composition in the heat-generating composition applying step; and a drying step for drying the woven fabric coated with the deodorizing component in the deodorizing component applying step. The woven fabric prepared by the procedures is coated with a deodorizing component and a heat-generating composition and thus excellent in the deodorizing and heat-generating effects.

### BACKGROUND OF THE INVENTION

1. Field of the Invention

The present invention relates to a method for preparing a woven fabric excellent in deodorizing and heat-generating effects and, more particularly, to a method for preparing a woven fabric excellent in deodorizing and heat-generating effects, which woven fabric is coated with a deodorizing component and a heat-generating composition to have good deodorizing and heat-generating effects.

2. Background Art

The present invention is directed to a method for preparing a woven fabric excellent in deodorizing and heat-generating effects and, more particularly, to a method for preparing a woven fabric coated with a deodorizing component and a heat-generating composition and thus excellent in deodorizing and heat-generating effects.

A new trend of woven fabrics has begun with an increasing demand for functional fabrics provided with a separate function as well as an inherent function for clothing. The woven fabrics in cold areas or in cold weather conditions, for example, are supposed to have a function to increase or keep the body temperature through the wearing of clothing.

For such a function of increasing or keeping the body temperature, it has been generally suggested to wear a thick piece of clothing or clothing designed for preventing a loss of body temperature. However, the wearing of a thick piece of clothing imposes a restraint to the free movement of the person who is wearing the clothing. Further, even the wearing of clothing for prevention of a loss of body temperature can end up with a loss of body temperature when staying outdoors for a long time in the cold weather conditions.

### SUMMARY OF THE INVENTION

Accordingly, it is an object of the present invention to provide a method for preparing a woven fabric excellent in deodorizing and heat-generating effects, which woven fabric can give a feeling of warmness for a long time without causing skin irritations when in contact with the skin and provide a good deodorizing effect.

It is another object of the present invention to provide a method for preparing a woven fabric excellent in deodorizing and heat-generating effects, which woven fabric has a function of preventing skin cancer with a coating of a UV blocking agent as well as a heat-generating function.

It is still another object of the present invention to provide a method for preparing a woven fabric excellent in deodorizing and heat-generating effects, which woven fabric contains a deodorizing component and a deodorant powder to provide a deodorizing function and prevent excessive perspiration.

To accomplish the above objects, according to the present invention, there is provided a method for preparing a woven fabric excellent in deodorizing and heat-generating effects, comprising: a heat-generating composition preparation step for blending a component providing a feeling of warmness to prepare a heat-generating composition; a heat-generating composition applying step for applying the heat-generating composition of the heat-generating composition preparation step onto a woven fabric; a deodorizing component applying step for applying a deodorizing component onto the woven fabric coated with the heat-generating composition in the heat-generating composition applying step; and a drying step for drying the woven fabric coated with the deodorizing component in the deodorizing component applying step.

In accordance with a preferred embodiment of the present invention, the method further comprises, between the deodorizing component applying step and the drying step, applying a UV blocking component onto the absorbent woven fabric coated with the deodorizing component in the deodorizing component applying step.

In accordance with a further preferred embodiment of the present invention, the heat-generating composition comprises 100 parts by weight of a collagen powder, 10 to 70 parts by weight of a ginger extract, 10 to 35 parts by weight of a surfactant, and 20 to 70 parts by weight of a silicon softener.

In accordance with a still further preferred embodiment of the present invention, the surfactant comprises at least one selected from the group consisting of polyoxyethylene alkylarylether and sorbitan fatty acid ester.

In accordance with a still further preferred embodiment of the present invention, the heat-generating composition further comprises 5 to 35 parts by weight of capsaicin.

In accordance with a still further preferred embodiment of the present invention, the heat-generating composition further comprises a heat-generating component, which comprises 100 parts by weight of a water-based acryl emulsion, 90 to 110 parts by weight of water, 10 to 15 parts by weight of carbon black, 2 to 5 parts by weight of a thickener, 4 to 6 parts by weight of toluene, 2 to 4 parts by weight of texanol, 2 to 4 parts by weight of ethylene glycol, and 2 to 4 parts by weight of a fluorocarbon resin.

In accordance with a still further preferred embodiment of the present invention, the deodorizing component comprises at least one selected from the group consisting of a titanium compound, saponin, a cryptomeria japonica leaf extract, sorbitol, terpene, camphor, and flavonoid.

In accordance with a still further preferred embodiment of the present invention, the deodorizing component further comprises a deodorant powder.

In accordance with a still further preferred embodiment of the present invention, the drying step is conducted using a tumble dryer at 110 to 150° C. for 10 to 30 minutes.

The method for preparing a woven fabric excellent in deodorizing and heat-generating effects according to the present invention can effectively provide a woven fabric that gives a feeling of warmness for a long time without causing irritations on the skin when in contact with the skin and provides a good deodorizing effect.

The method of the present invention can also provide a woven fabric that has a function of preventing occurrence of skin cancer with a coating of a UV blocking agent as well as a heat-generating effect.

The method of the present invention can also provide a woven fabric that contains a deodorizing component and a deodorant powder to provide a deodorizing effect and prevent excessive perspiration.

### BRIEF DESCRIPTION OF THE DRAWINGS

FIG. 1 is a flow chart showing a method for preparing a woven fabric excellent in deodorizing and heat-generating effects in accordance with an embodiment of the present invention.

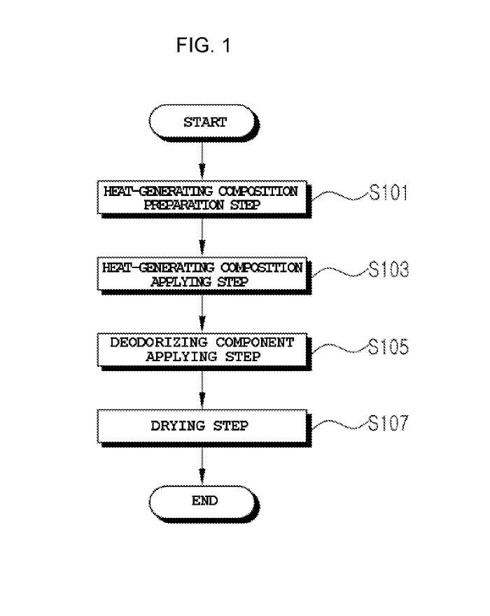

FIG. 2 is a flow chart showing a method for preparing a woven fabric excellent in deodorizing and heat-generating effects in accordance with another embodiment of the present invention.

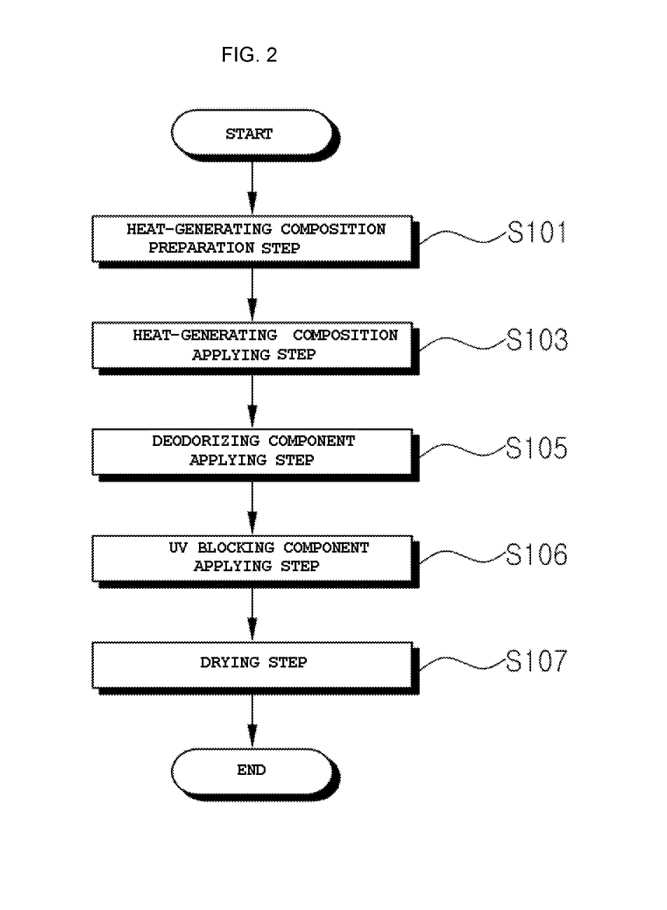

### DETAILED DESCRIPTION OF THE PREFERRED EMBODIMENT

Hereinafter, the preferred embodiments of the present invention and the properties of each component will be described in detail, which are for illustrations only for the skilled in the art to realize the present invention with ease and not intended to limit the spirit and scope of the present invention.

The method for preparing a woven fabric excellent in deodorizing and heat-generating effects according to the present invention comprises: a heat-generating composition preparation step S101 for blending a component for providing a feeling of warmness to prepare a heat-generating composition; a heat-generating composition applying step S103 for applying the heat-generating composition prepared in the heat-generating composition preparation step S101 onto a woven fabric; a deodorizing component applying step S105 for applying a deodorizing component onto the woven fabric coated with the heat-generating composition in the heat-generating composition applying step S103; and a drying step S107 for drying the woven fabric coated with the deodorizing component in the deodorizing component applying step S105.

The heat-generating composition preparation step S101 is blending a component for providing a feeling of warmness to prepare a heat-generating composition. The step S101 includes adding 100 parts by weight of a collagen powder, 10 to 70 parts by weight of a ginger extract, 10 to 35 parts by weight of a surfactant, and 20 to 70 parts by weight of a silicon softener into an agitator to prepare a heat-generating composition under agitation.

When the heat-generating composition is applied to a woven fabric, the collagen powder serves to maintain skin hydration to make the skin moisturized and elastic. The collagen component makes up 70 to 80% of the skin in a human body and decreases in quantity with age to cause a progress of skin aging. The heat-generating composition contains 100 parts by weight of the collagen powder.

The ginger extract is contained in an amount of 10 to 70 parts by weight. The content of the ginger extract less than 10 parts by weight deteriorates the heat-generating effect in proportion to the reduced content, whereas the content of the ginger extract greater than 70 parts by weight deteriorates the storage stability of the heat-generating composition.

The ginger extract contains, as a main ingredient, gingerol represented by (S)-5-hydroxy-1-(4-hydroxy-3-methoxyphenyl)-3-decanone and has good effects of preventing inflammation, suppressing the growth of germs, and increasing the blood flow rate.

The surfactant, which is a component that helps the oil and water phases contained in the heat-generating component miscible, is contained in an amount of 10 to 35 parts by weight. The content of the surfactant less than 10 parts by weight leads to insufficient emulsification of the oil and water phases and deteriorates the stability of the composition, whereas the content of the surfactant greater than 35 parts by weight deteriorates the stability of the heat-generating composition and lowers the activity of the ginger extract.

The surfactant as used herein should be a surfactant suitable to a heat-generating composition for processing a woven fabric, and nonionic surfactants are particularly effective.

The examples of the nonionic surfactants may include ether surfactants, ester surfactants, or a mixture of these and, more specifically, polyoxyethylene alkylaryl ether, sorbitan fatty acid ester, or a mixture of these.

The silicon softener serves to soften the woven fabric coated with the heat-generating composition and also acts as a binder that helps immobilization of the ginger extract in the fabric yarns of the woven fabric and provides durability. The content of the silicon softener in the composition is preferably in the range of 20 to 70 parts by weight.

The heat-generating composition, which is prepared as a liquid by mixing the collagen powder, the ginger extract, the surfactant, and the silicon softener with a balance amount of purified water, remains stable without solid-liquid separation even after storage for more than one year at the room temperature and takes a brownish thickened liquid that is nonionic and weakly acidic and neutral.

The heat-generating composition may further comprise 10 to 35 parts by weight of capsaicin to enhance the heat-generating efficiency of the heat-generating composition.

The capsaicin, which is an extract isolated from natural plants, can be a natural capsaicin or a synthetic capsaicin. For an effective heat-generating effect, a synthetic capsaicin is preferably used.

The content of the capsaicin less than 5 parts by weight has an insignificant effect of enhancing the heat-generating effect, whereas the content of the capsaicin greater than 10 parts by weight leads to deterioration of the storage stability.

The heat-generating composition may further comprise a heat-generating component, which comprises 100 parts by weight of a water-based acryl emulsion, 90 to 110 parts by weight of water, 10 to 15 parts by weight of carbon black, 2 to 5 parts by weight of a thickener, 4 to 6 parts by weight of toluene, 2 to 4 parts by weight of texanol, 2 to 4 parts by weight of ethylene glycol, and 2 to 4 parts by weight of a fluorocarbon resin. The heat-generating composition comprising such a heat-generating component is preferably contained in an amount of 20 to 30 parts by weight with respect to 100 parts by weight of the collagen powder.

The content of the heat-generating component less than 20 parts by weight provides an insignificant effect of enhancing the heat-generating performance, whereas the content of the heat-generating component greater than 30 parts by weight leads to an excessive increase in the production cost.

The addition of the heat-generating component with the above composition not only increases the heat-generating effect but also enhances the adhesion of the heat-generating composition to the woven fabric and the properties of the composition of the present invention applied on the woven fabric.

The carbon black is added in an amount of 10 to 15 parts by weight with respect to 100 parts by weight of the water-based acryl emulsion and has such a high thermal conductivity as to help a uniform release of the heat from all over the heat-generating composition.

The content of the carbon black less than 10 parts by weight cannot acquire a uniform release of the heat from the heat-generating composition, whereas the content of the carbon black greater than 15 parts by weight results in a rise of the production expense and deteriorates the adhesion strength and durability of the heat-generating composition.

The thickener is added in an amount of 2 to 5 parts by weight with respect to 100 parts by weight of the water-based acryl emulsion and used to enhance the viscosity of the heat-generating composition and control the adhesion strength. The content of the thickener less than 2 parts by weight leads to the low viscosity of the heat-generating composition, with a risk of causing a phase separation of the carbon black with an elapse of time, whereas the content of the thickener greater than 5 parts by weight excessively increases the viscosity of the heat-generating composition to deteriorate workability.

The toluene is added in an amount of 4 to 6 parts by weight with respect to 100 parts by weight of the water-based acryl emulsion. The content of the toluene less than 4 parts by weight deteriorates the smoothness of the heat-generating composition, whereas the content of the toluene greater than 6 parts by weight deteriorates the adhesion strength of the heat-generating composition.

The texanol serves to help formation of a coating layer of the heat-generating composition even at a low temperature and is preferably used in an amount of 2 to 4 parts by weight with respect to 100 parts by weight of the water-based acryl emulsion. The content of the texanol less than 2 parts by weight cannot form a coating layer of the heat-generating composition on the woven fabric, whereas the content of the texanol greater than 4 parts by weight leads to deterioration in the adhesion strength of the water-based acryl emulsion.

The ethylene glycol serves to enhance the cold resistance of the coating layer comprised of the heat-generating composition and is added in an amount of 2 to 4 parts by weight with respect to 100 parts by weight of the water-based acryl emulsion. The content of the ethylene glycol less than 2 parts by weight provides an insignificant effect of enhancing the cold resistance of the heat-generating composition, whereas the content of the ethylene glycol greater than 4 parts by weight leads to deterioration in the adhesion strength of the heat-generating composition.

The fluorocarbon resin serves to enhance the chemical resistance and the flame resistance of the heat-generating composition and is added in an amount of 2 to 4 parts by weight with respect to 100 parts by weight of the water-based acryl emulsion. The content of the fluorocarbon resin less than 2 parts by weight provides an insignificant effect of enhancing the chemical resistance and the flame resistance of the heat-generating composition, whereas the content of the fluorocarbon resin greater than 4 parts by weight deteriorates the adhesion strength of the heat-generating composition.

The heat-generating composition applying step S103 is to apply the heat-generating composition prepared in the heat-generating composition preparation step S101 onto a woven fabric. In the heat-generating composition applying step S103, the heat-generating composition is applied on the surface of the woven fabric by spraying it on the woven fabric or soaking the woven fabric with it.

The amount of the heat-generating composition used in the heat-generating composition applying step S103 is preferably in the range of 60 to 80 parts by weight with respect to 100 parts by weight of the woven fabric.

The woven fabric as used herein may include any woven fabric comprised of different yarns, such as natural fiber yarn, blended yarn, synthetic fiber yarn, etc. Preferably, the woven fabric is comprised of a synthetic fiber yearn. The heat-generating performance can increase when the heat-generating composition is applied to the woven fabric comprising a blended yarn or a synthetic fiber yarn, including amide-based fibers (e.g., nylon), polyester-based fibers, or polyurethane-based fibers.

The deodorizing component applying step S105 is applying a deodorizing component onto the woven fabric coated with the heat-generating composition in the heat-generating composition applying step S103. For this, 5 to 20 parts by weight of a deodorizing component is sprayed on 100 parts by weight of the woven fabric coated with the heat-generating composition in the heat-generating composition applying step S103, to suppress odor emission caused by the sweat from the body.

If not including the deodorizing component, the woven fabric prepared by the method for preparing a woven fabric excellent in deodorizing and heat-generating effects can have a shorter wash time cycle, which results in a reduced release time of the heat-generating composition applied on the surface of the woven fabric by wash, reducing the period of time for providing the feeling of warmness.

Preferably, the deodorizing component comprises at least one selected from the group consisting of a titanium compound, saponin, a cryptomeria japonica leaf extract, sorbitol, terpene, camphor, and flavonoid. The deodorizing component may further comprise 50 to 60 parts by weight of a deodorant powder for preventing excessive perspiration, which content is given with respect to 100 parts by weight of the deodorizing component.

The drying step S107 is drying the woven fabric coated with the deodorizing component in the deodorizing component applying step S105. In this step S107, the woven fabric coated with the deodorizing component is dried after dehydration with a dehydrating means such as padding rollers, to more firmly adhere the heat-generating composition to the woven fabric.

The drying step S107 is preferably conducted using a tumble dryer at 110 to 150° C. for 10 to 30 minutes.

The drying step S107 ends up with a woven fabric excellent in deodorizing and heat-generating effects, and a wearing of clothing made of the woven fabric can keep the body temperature due to the heat-generating composition applied to the woven fabric in association with the heat emitted from the body.

Further, the heat-generating composition and the deodorizing component applied to the woven fabric provide durability high enough to maintain the heat-generating property even after 30 times of wash and give antibacterial and anti-humidity effects as well as the deodorizing effect, realizing a refreshing feeling during a wearing of clothing.

Between the deodorizing component applying step S105 and the drying step S107 is provided a UV blocking component applying step S106 for applying a UV blocking component to the woven fabric coated with the deodorizing component in the deodorizing component applying step S105. This step S106 is spraying 2.5 to 10 parts by weight, preferably 5 parts by weight of a UV blocking component on 100 parts by weight of the woven fabric coated with the deodorizing component in the deodorizing component applying step S105.

The UV blocking component plays a role of skin protection against UV light and comprises at least one selected from the group consisting of padimate O, octinoxate (octyl methoxycinnamate), octisalate (octyl salicylate), octocrylene, ensulizole (phenylbenzimidazole sulfonic acid), oxybenzone, meradimate (methyl anthranilate), avobenzone (butyl methoxydibenzoylmethane), titanium dioxide, and zinc oxide.

Hereinafter, a description will be given as to the heat-generating effect of a woven fabric prepared by the method for preparing a woven fabric excellent in deodorizing and heat-generating effects according to the present invention by way of examples.

### Example 1

40 parts by weight of a ginger extract and 20 parts by weight of sorbitan fatty acid ester were put in a homogenizer equipped with a homo mixer and stirred at high rate of 2500 rpm for 60 minutes. After agitation, 45 parts by weight of a silicon softener (Orinstar SFSEC, Oringe Inc.) was added little by little for 30 minutes, and the mixture was homogenized under agitation at 2500 rpm for 60 minutes. 30 parts by weight of purified water was added little by little for 60 minutes, and the mixture was stirred at 2300 rpm for 60 minutes to prepare an emulsion. The emulsion was mixed with an aqueous collagen solution containing 100 parts by weight of a collagen powder and 150 parts by weight of purified water and then stirred at 1800 rpm for 60 minutes to prepare a heat-generating composition. 70 parts by weight of the heat-generating composition was spray-coated with a sprayer on 100 parts by weight of a woven fabric (polyester-polyurethane blended tricot fabric: polyester 77%, 20D polyurethane 23%, weight 148.2 g/m² as measured by ks K 0514:2006). Then, 10 parts by weight of a deodorizing component comprised of a titanium compound was applied to 100 parts by weight of the woven fabric coated with the heat-generating composition. The woven fabric coated with the deodorizing component was dried out in a tumble drier at 130° C. for 20 minutes to produce a woven fabric excellent in deodorizing and heat-generating effects.

### Example 2

The procedures were performed in the same manner as described in Example 1, excepting that 20 parts by weight of a ginger extract, 20 parts by weight of sorbitan fatty acid ester, and 20 parts by weight of capsaicin were added to prepare a woven fabric excellent in deodorizing and heat-generating effects.

### Comparative Example 1

Polyester-polyurethane blended tricot fabric (polyester 77%, 20D polyurethane 23%, weight 148.2 g/m² as measured by ks K 0514:2006).

The woven fabrics prepared in Examples 1 and 2 and Comparative Example 1 were made into sleeveless undershirts, each of which was provided with a thermometer and put on a subject to measure the change of temperature indicated by the thermometer with an elapse of time. The measurement results are presented in Table 1.

The change of temperature was measured with a skin thermo-hydrometer (LT-8B, Gram) in an environment simulation chamber (EBE Walk-in, ESPEC).

The testing procedures were as follows:

(a) Set the temperature and humidity of an environment simulation chamber as designated by a requester: 25±2° C., 50±4% R.H.
(b) Have a subject with only a sleeveless undershirt on be seated and stabilized for 30 minutes in the environment simulation chamber.
(c) With a contact type skin thermo-hydrometer attached on the undershirt, have the subject wearing the shirt be seated and stabilized for 60 minutes, and measure the surface temperature of the undershirt made of the woven fabric of Comparative Example 1.
(d) 48 hours after the testing, repeat the procedures (a), (b) and (c) on a subject wearing an undershirt made of the woven fabric of Example 1 or 2.

TABLE 1

| | Time (min) | | | | | | |
|---|---|---|---|---|---|---|---|
| Div. | 0 | 10 | 20 | 30 | 40 | 50 | 60 |
| Example 1 | 31.25 | 33.90 | 33.28 | 33.96 | 34.92 | 35.29 | 35.59 |
| Example 2 | 31.24 | 33.95 | 33.98 | 34.05 | 34.03 | 35.58 | 35.77 |
| Comparative | 32.09 | 31.93 | 31.40 | 32.16 | 31.99 | 31.47 | 31.59 |
| Example 1 | | | | | | | |

As can be seen from Table 1, the undershirts made of the woven fabrics prepared by the method for preparing a woven fabric excellent in deodorizing and heat-generating effects according to the present invention had a good heat-generating performance with an elapse of time.

Further, the woven fabric, which is comprised of components causing no skin irritation when in contact with the skin, causes no skin irritation, maintains a heat-generating effect even after 30 times of wash, and has a good deodorizing effect.

Aside from the heat-generating effect, the woven fabric can suppress occurrence of skin cancer with a coating of a UV blocking component and prevent excessive perspiration due to an addition of a deodorant powder.

What is claimed is:

1. A method for preparing a woven fabric excellent in deodorizing and heat-generating effects, comprising:
a heat-generating composition preparation step for blending a component providing a feeling of warmness to prepare a heat-generating composition;
a heat-generating composition applying step for applying the heat-generating composition of the heat-generating composition preparation step onto a woven fabric;
a deodorizing component applying step for applying a deodorizing component onto the woven fabric coated with the heat-generating composition in the heat-generating composition applying step; and
a drying step for drying the woven fabric coated with the deodorizing component in the deodorizing component applying step.

2. The method as claimed in claim 1, further comprising:
between the deodorizing component applying step and the drying step, applying a UV blocking component onto the absorbent woven fabric coated with the deodorizing component in the deodorizing component applying step.

3. The method as claimed in claim 1, wherein the heat-generating composition comprises 100 parts by weight of a collagen powder, 10 to 70 parts by weight of a ginger extract, 10 to 35 parts by weight of a surfactant, and 20 to 70 parts by weight of a silicon softener.

4. The method as claimed in claim 3, wherein the surfactant comprises at least one selected from the group consisting of polyoxyethylene alkylarylether and sorbitan fatty acid ester.

5. The method as claimed in claim 3, wherein the heat-generating composition further comprises 5 to 35 parts by weight of capsaicin.

6. The method as claimed in claim 5, wherein the heat-generating composition further comprises a heat-generating component,
the heat-generating component comprising 100 parts by weight of a water-based acryl emulsion, 90 to 110 parts by weight of water, 10 to 15 parts by weight of carbon black, 2 to 5 parts by weight of a thickener, 4 to 6 parts by weight of toluene, 2 to 4 parts by weight of texanol, 2 to 4 parts by weight of ethylene glycol, and 2 to 4 parts by weight of a fluorocarbon resin.

7. The method as claimed in claim 1, wherein the deodorizing component comprises at least one selected from the group consisting of a titanium compound, saponin, a cryptomeria japonica leaf extract, sorbitol, terpene, camphor, and flavonoid.

8. The method as claimed in claim 8, wherein the deodorizing component further comprises a deodorant powder.

9. The method as claimed in claim 1, wherein the deodorizing component further comprises a deodorant powder.

10. The method as claimed in claim 1, wherein the drying step is conducted using a tumble dryer at 110 to 150° C. for 10 to 30 minutes.
